(19) United States
(12) Patent Application Publication
(10) Pub. No.: US 2024/0361513 A1
(43) Pub. Date: Oct. 31, 2024

(54) ELECTRONIC DEVICE

(71) Applicant: VIVO MOBILE COMMUNICATION CO., LTD., Dongguan (CN)

(72) Inventors: Lingbing KONG, Dongguan (CN); Qinming CAI, Dongguan (CN)

(73) Assignee: VIVO MOBILE COMMUNICATION CO., LTD., Dongguan (CN)

(21) Appl. No.: 18/770,633

(22) Filed: Jul. 11, 2024

Related U.S. Application Data
(63) Continuation of application No. PCT/CN2023/071302, filed on Jan. 9, 2023.

(30) Foreign Application Priority Data
Jan. 12, 2022 (CN) 202210033630.3

(51) Int. Cl. F21V 8/00

(52) U.S. Cl. CPC G02B 6/0083; G02B 6/0036

(57) ABSTRACT

An electronic device is provided, including a housing, a circuit board, an infrared generator, and a light guide member. The housing is provided with a light-transmitting hole and an accommodating cavity for accommodating the circuit board, the infrared generator, and the light guide member. The infrared generator is mounted on the circuit board. The light guide member includes a light incident surface and a light exit surface. The light guide member is at least partially arranged in the light-transmitting hole. The light incident surface and the light exit surface are arranged in a staggered manner. The light incident surface is arranged corresponding to the infrared generator, and the light incident surface is an aspherical curved surface. Infrared light emitted by the infrared generator emits outward through the light guide member.

### CROSS-REFERENCE TO RELATED APPLICATIONS

This application is a continuation of International Application No. PCT/CN2023/071302, filed on Jan. 9, 2023, which claims priority to Chinese Patent Application 202210033630.3, filed Jan. 12, 2022. The entire contents of each of the above-identified applications are expressly incorporated herein by reference.

### TECHNICAL FIELD

This application relates to the field of communication technologies, and specifically, to an electronic device.

### BACKGROUND

As functions of an electronic device gradually increase, infrared remote control is an important function of the electronic device. By installing an infrared module in the electronic device, the electronic device is enabled to control a smart home device such as a television, an air conditioner, and the like, thereby greatly improving comfort of home life.

Currently, a light and thin design in the electronic device is a mainstream trend. To improve performance of the infrared remote control of the electronic device, it is necessary to limit a positional relationship between an infrared generator and a light guide member in the electronic device, so that a center of the light guide member is aligned with a center of the infrared generator, and a relationship between the infrared module and another structural device of the electronic device affects an overall stacking thickness of the electronic device.

### SUMMARY

Embodiments of this application provide an electronic device.

According to a first aspect, an embodiment of this application provides an electronic device, where the electronic device includes a housing, a circuit board, an infrared generator, and a light guide member;
the housing is provided with a light-transmitting hole and an accommodating cavity for accommodating the circuit board, the infrared generator, and the light guide member;
the infrared generator is mounted on the circuit board; and
the light guide member includes a light incident surface and a light exit surface, the light guide member is at least partially arranged in the light-transmitting hole, the light incident surface and the light exit surface are arranged in a staggered manner, the light incident surface is arranged corresponding to the infrared generator, the light incident surface is an aspherical curved surface, and
infrared light emitted by the infrared generator emits outward through the light guide member.

The electronic device in embodiments of this application includes the housing, the circuit board, the infrared generator, and the light guide member. The housing is provided with the light-transmitting hole and the accommodating cavity for accommodating the circuit board, the infrared generator, and the light guide member. The infrared generator is mounted on the circuit board. The light guide member includes the light incident surface and the light exit surface. The light guide member is at least partially arranged in the light-transmitting hole. The light exit surface and the light-transmitting hole are arranged oppositely. The light incident surface and the light exit surface are arranged in the staggered manner. The light incident surface is arranged corresponding to the infrared generator, and the light incident surface is the aspherical curved surface. The infrared light emitted by the infrared generator emits outward through the light guide member. In embodiments of this application, by adjusting an optical path of the infrared light emitted by the infrared generator in the light guide member, the infrared light is enabled to pass through the light exit surface and the light-transmitting hole to emit outward, to improve performance of infrared remote control of the electronic device without affecting an overall stacking thickness of the electronic device.

### BRIEF DESCRIPTION OF THE DRAWINGS

FIG. 1 is an exploded view of an electronic device according to an embodiment of this application;

FIG. 2 is a cross-sectional view of an electronic device according to an embodiment of this application;

FIG. 3 is a first block diagram of an electronic device according to an embodiment of this application;

FIG. 4 is a second block diagram of an electronic device according to an embodiment of this application;

FIG. 5 is a third block diagram of an electronic device according to an embodiment of this application; and

FIG. 6 is a fourth block diagram of an electronic device according to an embodiment of this application.

### DETAILED DESCRIPTION

With reference to accompanying drawings in embodiments of this application, the following describes technical solutions in embodiments of this application. It is clear that the described embodiments are some but not all of embodiments of this application. All other embodiments obtained by a person of ordinary skill in the art based on embodiments of this application without creative efforts shall fall within the protection scope of this application.

In the specification and claims of this application, the terms “first” and “second” are used to distinguish similar objects, but do not necessarily indicate a specific order or sequence. It should be understood that data used in such a way is interchangeable in proper circumstances, so that embodiments of this application described herein can be implemented in a sequence other than the sequence illustrated or described herein. In addition, the term “and/or” in the specification and claims represents at least one of the connected objects, and the character “/” generally indicates an “or” relationship between the associated objects.

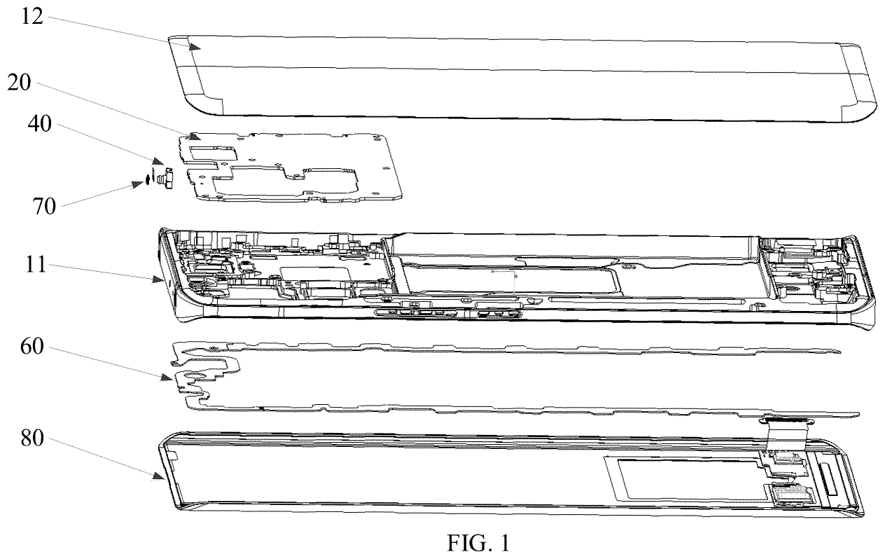

FIG. 1 is an exploded view of an electronic device according to an embodiment of this application. As shown in FIG. 1 to FIG. 3, the electronic device includes a housing 10, a circuit board 20, an infrared generator 30, and a light guide member 40.

The housing 10 is provided with a light-transmitting hole and an accommodating cavity for accommodating the circuit board 20, the infrared generator 30, and the light guide member 40.

The infrared generator 30 is mounted on the circuit board 20.

The light guide member 40 includes a light incident surface 41 and a light exit surface 42. The light guide member 40 is at least partially arranged in the light-transmitting hole. The light incident surface 41 and the light exit surface 42 are arranged in a staggered manner. The light incident surface 41 is arranged corresponding to the infrared generator 30, and the light incident surface 41 is an aspherical curved surface.

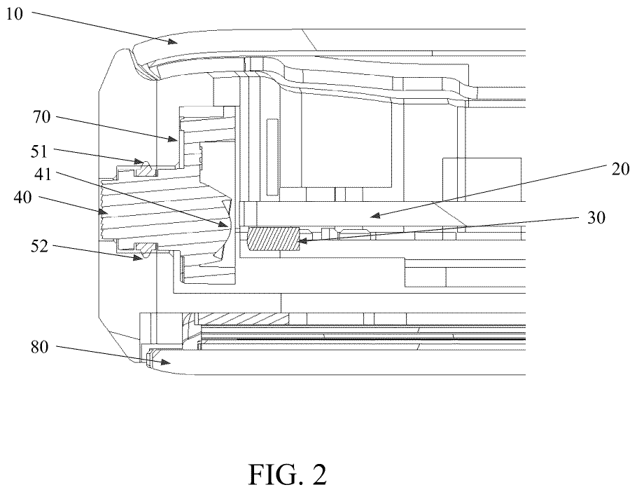

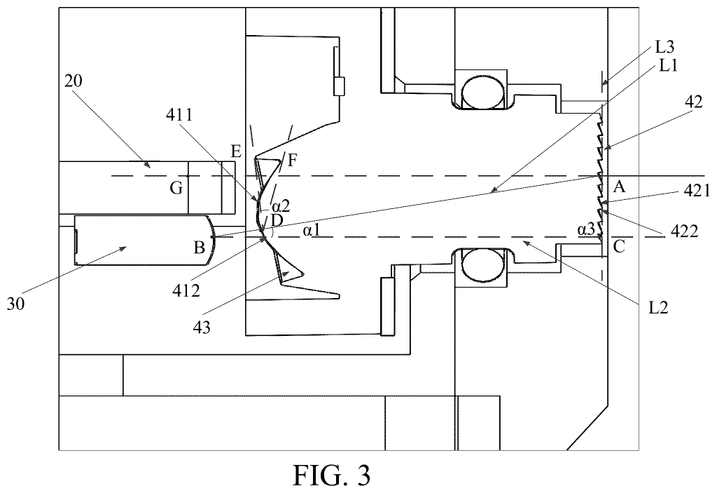

Refer to FIG. 2 and FIG. 3. FIG. 2 is a cross-sectional view of an electronic device according to an embodiment of this application. FIG. 3 is a first schematic diagram of a structure of an electronic device according to an embodiment of this application. The electronic device provided in this embodiment includes a housing 10, a circuit board 20, an infrared generator 30, and a light guide member 40. The circuit board 20 may be a PCB. The housing 10 includes a casing 11 and a cover plate 12.

Refer to FIG. 3. In this embodiment, the housing 10 is provided with a light-transmitting hole. The light guide member 40 is at least partially arranged in the light-transmitting hole. The light guide member 40 includes a light incident surface 41 and a light exit surface 42. Infrared light emitted by the infrared generator 30 is incident into the light guide member 40 through the light incident surface 41, and at least part of the infrared light is refracted to the light exit surface 42 through the light incident surface 41 of the light guide member 40, and passes through the light exit surface 42 and the light-transmitting hole to emit outward, thereby implementing a function of infrared remote control.

The electronic device in embodiments of this application includes a housing 10, a circuit board 20, an infrared generator 30, and a light guide member 40. The housing 10 is provided with a light-transmitting hole and an accommodating cavity for accommodating the circuit board 20, the infrared generator 30, and the light guide member 40. The infrared generator 30 is mounted on the circuit board 20. The light guide member 40 includes a light incident surface 41 and a light exit surface 42. The light guide member 40 is at least partially arranged in the light-transmitting hole. The light incident surface 41 and the light exit surface 42 are arranged in a staggered manner. The light incident surface 41 is arranged corresponding to the infrared generator 30, and the light incident surface 41 is an aspherical curved surface. The infrared light emitted by the infrared generator 30 emits outward through the light guide member 40. In embodiments of this application, by adjusting an optical path of the infrared light emitted by the infrared generator 30 in the light guide member 40, the infrared light is enabled to pass through the light exit surface 42 and the light-transmitting hole to emit outward, thereby improving performance of the infrared remote control of the electronic device without affecting an overall stacking thickness and increasing costs of the electronic device.

In some implementations, the light incident surface 41 includes a first curved surface 411 and a second curved surface 412 that are connected to each other, and a curvature radius of the first curved surface 411 is greater than a curvature radius of the second curved surface 412.

Refer to FIG. 3. As shown in FIG. 3, the light incident surface 41 includes a first curved surface 411 and a second curved surface 412 that are connected to each other. In a cross-sectional view shown in FIG. 3, the first curved surface 411 and the second curved surface 412 can be distinguished by using a line connecting a central light exit point A of the light exit surface 42 and a central point B of the infrared generator 30 as a boundary.

It should be understood that the light exit surface 42 includes a plurality of light exit points, and the central light exit point is a light exit point located at a center of the light exit surface 42, that is, a point A in FIG. 3. The central point of the infrared generator is one of light exit points where the infrared generator emits the infrared light, that is, a point B in FIG. 3. The curvature radius of the first curved surface 411 is greater than the curvature radius of the second curved surface 412, so that a propagation path of the infrared light in the light guide member 40 is adjusted, thereby implementing deflection of the infrared light.

In some implementations, a distance between the first curved surface 411 and the circuit board 20 is less than a distance between the second curved surface 412 and the circuit board 20.

As shown in FIG. 3, the first curved surface 411 and the second curved surface 412 can be distinguished by using the line connecting the central light exit point of the light exit surface 42 and the central point of the infrared generator 30 as a boundary. The distance between the first curved surface 411 and the circuit board 20 is less than the distance between the second curved surface 412 and the circuit board 20.

As shown in FIG. 3, a line AG is an optical axis corresponding to the light exit surface 42, the entire circuit board 20 is below the line AG, and the entire light incident surface 41 is below the line AG. The infrared generator 30 is mounted on the circuit board 20 and the entire infrared generator 30 is below the line AG. In this case, a distance between the infrared generator 30 and the light incident surface 41 is less than a distance between the infrared generator 30 and the light exit surface 42. In the electronic device shown in FIG. 3, a distance between the infrared generator 30 and the first curved surface 411 is less than a distance between the infrared generator 30 and the second curved surface 412. A positional relationship between the first curved surface 411, the second curved surface 412, and the circuit board 20 is limited in this embodiment, thereby implementing the deflection of the infrared light in the light guide member 40.

In some implementations, a first included angle between a target line L1 and a reference line L2 is less than 10 degrees, the target line L1 is the line connecting the central light exit point of the light exit surface 42 and the central point of the infrared generator 30, and the reference line L2 is perpendicular to a plane where the light exit surface 42 is located.

As shown in FIG. 3, the point A is the central light exit point of the light exit surface 42; and the point B is the central point of the infrared generator 30, that is, one of the light exit points of the infrared generator that emits the infrared light. A line connecting the point A and the point B is referred to as the target line L1.

In the electronic device shown in FIG. 3, a dotted line L3 represents the plane where the light exit surface 42 is located. A line connecting the point B and a point C is perpendicular to the plane where the light exit surface 42 is located. The line connecting the point B and the point C is referred to as the reference line L2, and the point C is a point on the reference line L2. An included angle between the target line L1 and the reference line L2 is referred to as the first included angle, that is, α1 in FIG. 3. The first included angle is less than 10 degrees.

In some implementations, the light guide member 40 further includes a reflective surface 43, where the reflective surface 43 is annularly arranged around the light incident surface 41. A second included angle between a first line and a second line is less than twice the first included angle. The first line is a line connecting a central light incident point of the light incident surface 41 and a first endpoint of the reflective surface 43. The second line is a line connecting the central light incident point of the light incident surface 41 and a second endpoint of the reflective surface 43. The first endpoint is arranged on a side of the reflective surface 43 close to the infrared generator 30, and the second endpoint is arranged on a side of the reflective surface 43 away from the infrared generator 30.

As shown in FIG. 3, the light guide member 40 further includes a reflective surface 43, where the reflective surface 43 is also referred to as a block wall. In some implementations, the reflective surface 43 is annularly arranged around the light incident surface.

In this embodiment, an intersection point between the light incident surface 41 and the target line L1 may be referred to as the central light incident point of the light incident surface 41, that is, a point D in FIG. 3. An endpoint arranged on the side of the reflective surface 43 close to the infrared generator 30 is referred to as the first endpoint, that is, a point E in FIG. 3. An endpoint arranged on the side of the reflective surface 43 away from the infrared generator 30 is referred to as the second endpoint, that is, a point F in FIG. 3.

In this embodiment, a line connecting the point D and the point E is referred to as the first line, and a line connecting the point D and the point F is referred to as the second line. An included angle between the first line and the second line is referred to as the second included angle, that is, α2 in FIG. 3.

In this embodiment, to ensure the propagation path of the infrared light in the light guide member 40, the infrared light may be transmitted to the light exit point of the light exit surface 42, the propagation path of the infrared light in the light guide member 40 is shaped, and the second included angle is set to be less than twice the first included angle.

Only a second included angle corresponding to one reflective surface 43 is shown in FIG. 3. It should be understood that when the light guide member 40 includes a plurality of reflective surfaces 43, a second included angle corresponding to each reflective surface 43 is less than twice the first included angle.

In some implementations, the light exit surface 42 includes a sawtooth structure. The sawtooth structure includes a plurality of first sawtooth surfaces 421 and a plurality of second sawtooth surfaces 422. Each first sawtooth surface 421 and each second sawtooth surface 422 are arranged adjacently. An area of the first sawtooth surface 421 is greater than an area of the second sawtooth surface 422, and a third included angle between the first sawtooth surface 421 and the plane where the light exit surface 42 is located is less than twice the first included angle.

As shown in FIG. 3, the light exit surface 42 includes the sawtooth structure. The sawtooth structure includes the first sawtooth surface 421 and the second sawtooth surface 422, and the area of the first sawtooth surface 421 is greater than the area of the second sawtooth surface 422. An included angle between the first sawtooth surface 421 and the plane where the light exit surface 42 is located is referred to as the third included angle, that is, α3 in FIG. 3. The third included angle is set to be less than twice the first included angle, to implement deflection processing on the infrared light.

In some implementations, the central light incident point of the light incident surface 41 is located on a first side of the optical axis corresponding to the light exit surface 42.

The light exit surface 42 includes the sawtooth structure, and a tip of the sawtooth structure faces the first side.

The central light incident point of the light incident surface 41 is a light incident point located at a center of the light incident surface 41. As shown in FIG. 3, the line AG is the optical axis corresponding to the light exit surface 42. The central light incident point of the light incident surface 41 is arranged on the first side of the optical axis, and the tip of the sawtooth structure faces the first side of the optical axis. In other words, the tip of the sawtooth structure faces the same side of the optical axis corresponding to the light exit surface 42 where the central light incident point of the light incident surface 41 is located.

Refer to FIG. 3. In the light guide member shown in FIG. 3, the central light incident point of the light incident surface 41 is located below the optical axis corresponding to the light exit surface 42. In this way, to enable the infrared light incident into the light guide member 40 through the central light incident point of the light incident surface 41 to emit outward from the central light exit point of the light exit surface 42, the tip of the sawtooth structure of the light exit surface 42 is arranged to face downward, to adjust a light exit direction of the infrared light, so that the infrared light emits outward through the central light exit point of the light exit surface 42.

It should be understood that in another embodiment, if the central light incident point of the light incident surface 41 is located above the optical axis corresponding to the light exit surface 42, the tip of the sawtooth structure is arranged to face upward.

In some implementations, the light exit surface 42 includes a sawtooth structure, and a distance between tips of adjacent sawtooth structures is one-twelfth to one-eighth of a diameter of the light-transmitting hole.

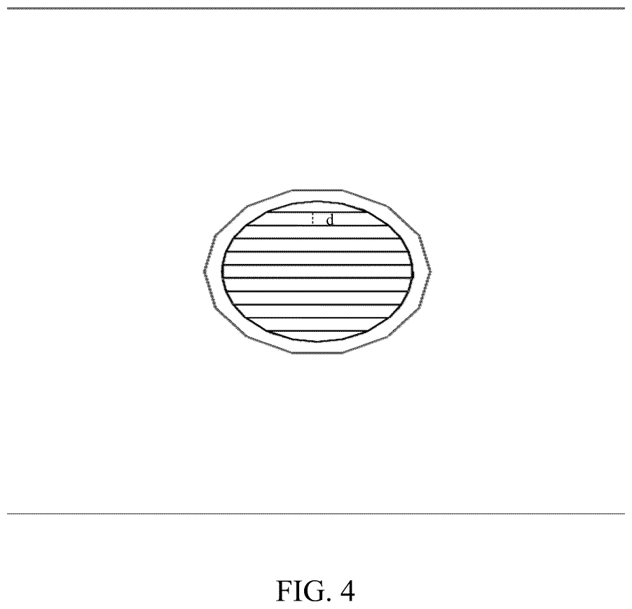

In this embodiment, the light exit surface 42 includes a sawtooth structure, and the sawtooth structure is configured to deflect the infrared light. Refer to FIG. 4. d in FIG. 4 represents the distance between tips of adjacent sawtooth structures. Distances between tips of all adjacent sawtooth structures are set to be equal, which is one-twelfth to one-eighth of the diameter of the light-transmitting hole. In some implementations, the distance between tips of adjacent sawtooth structures is set to one-tenth of the diameter of the light-transmitting hole.

In some implementations, the electronic device further includes a sealing member, where the sealing member is arranged between the housing 10 and the light guide member 40.

The electronic device provided in this embodiment further includes a sealing member. In some implementations, the sealing member is a silicone ring. The sealing member is arranged between the housing 10 and the light guide member 40, and there is interference between the sealing member and the housing 10, thereby ensuring scaling performance of the housing 10 and preventing water or another material from entering the inside of the housing 10.

In some implementations, the sealing member includes a first sealing member 51 and a second sealing member 52, and the first sealing member 51 and the second scaling member 52 are arranged adjacently.

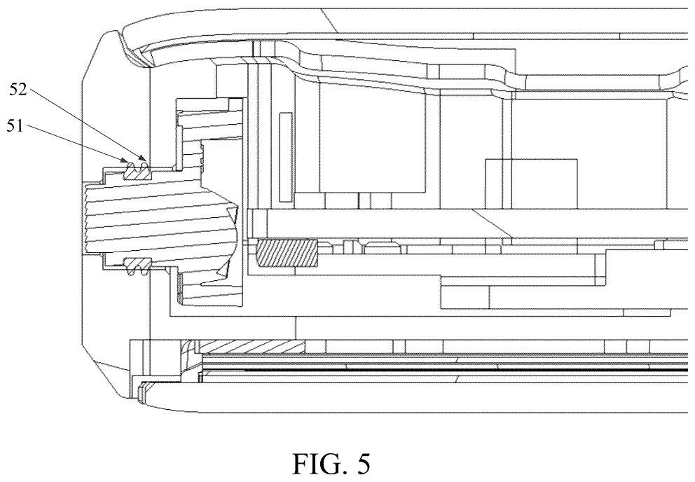

As shown in FIG. 5, the sealing member includes the first sealing member 51 and the second sealing member 52, and the first sealing member 51 and the second sealing member 52 are arranged adjacently and integrally. In this embodiment, two scaling members are arranged to further ensure the sealing performance of the housing 10.

In some implementations, the electronic device further includes a first bonding member 60 and a display module 80.

The display module 80 and the housing 10 are bonded through the first bonding member 60.

As shown in FIG. 1, the electronic device includes a first bonding member 60 and a display module 80. In some implementations, the first bonding member 60 may be a double-sided tape. The display module 80 is also referred to as a Liquid Crystal Display Module (LCDM).

As described above, the housing 10 includes a casing 11 and a cover plate 12. An accommodating cavity is formed between the cover plate 12 and the casing 11. The casing 11 and the display module 80 are bonded through the first bonding member 60.

In some implementations, the electronic device further includes a second bonding member 70, and the housing 10 and the light guide member 40 are bonded through the second bonding member 70.

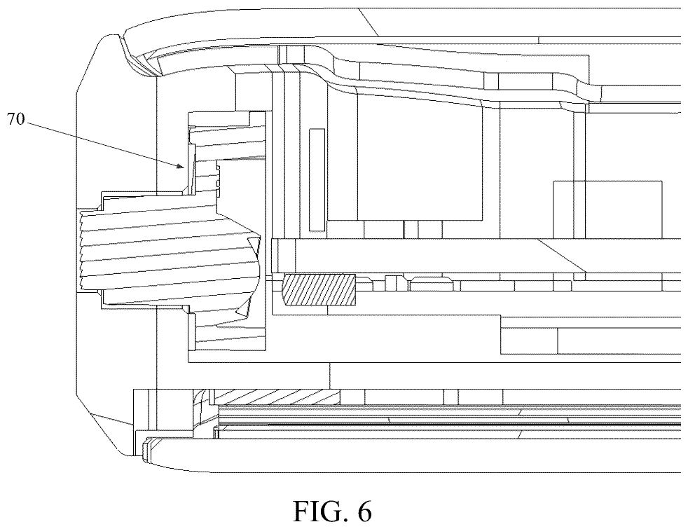

As shown in FIG. 6, the electronic device includes a second bonding member 70, where the second bonding member 70 includes but is not limited to the double-sided tape and glue. The housing 10 and the light guide member 40 are bonded through the second bonding member 70. In this embodiment, the second bonding member 70 is arranged between the housing 10 and the light guide member 40 to prevent water from entering the inside of the housing 10.

In embodiments of this application, the electronic device may be a computer, a mobile phone, a tablet personal computer, a laptop computer, a Personal Digital Assistant (PDA), a Mobile Internet Device (MID), a wearable device, an e-reader, a navigator, a digital camera, or the like.

The foregoing describes embodiments of this application with reference to the accompanying drawings. However, this application is not limited to the foregoing specific implementations. The foregoing specific implementations are merely exemplary, but are not limitative. Inspired by this application, a person of ordinary skill in the art may further make modifications without departing from the spirit of this application and the protection scope of the claims, and all the modifications shall fall within the protection of this application.

What is claimed is:

1. An electronic device, comprising:
a housing;
a circuit board;
an infrared generator; and
a light guide member, wherein:
the housing is provided with a light-transmitting hole and an accommodating cavity for accommodating the circuit board, the infrared generator, and the light guide member;
the infrared generator is mounted on the circuit board; and
the light guide member comprises a light incident surface and a light exit surface, the light guide member is at least partially arranged in the light-transmitting hole, the light incident surface and the light exit surface are arranged in a staggered manner, the light incident surface is arranged corresponding to the infrared generator, and the light incident surface is an aspherical curved surface, wherein
infrared light emitted by the infrared generator emits outward through the light guide member.

2. The electronic device according to claim 1, wherein the light incident surface comprises a first curved surface and a second curved surface that are connected to each other, and a curvature radius of the first curved surface is greater than a curvature radius of the second curved surface.

3. The electronic device according to claim 2, wherein a distance between the first curved surface and the circuit board is less than a distance between the second curved surface and the circuit board.

4. The electronic device according to claim 1, wherein a first included angle between a target line and a reference line is less than 10 degrees, the target line is a line connecting a central light exit point of the light exit surface and a central point of the infrared generator, and the reference line is perpendicular to a plane where the light exit surface is located.

5. The electronic device according to claim 4, wherein:
the light guide member further comprises a reflective surface,
the reflective surface is annularly arranged around the light incident surface,
a second included angle between a first line and a second line is less than twice the first included angle,
the first line is a line connecting a central light incident point of the light incident surface and a first endpoint of the reflective surface,
the second line is a line connecting the central light incident point of the light incident surface and a second endpoint of the reflective surface,
the first endpoint is arranged on a side of the reflective surface close to the infrared generator, and
the second endpoint is arranged on a side of the reflective surface away from the infrared generator.

6. The electronic device according to claim 4, wherein:
the light exit surface comprises a sawtooth structure,
the sawtooth structure comprises a first sawtooth surface and a second sawtooth surface,
an area of the first sawtooth surface is greater than an area of the second sawtooth surface, and
a third included angle between the first sawtooth surface and the plane where the light exit surface is located is less than twice the first included angle.

7. The electronic device according to claim 1, wherein:
a central light incident point of the light incident surface is located on a first side of an optical axis corresponding to the light exit surface, and
the light exit surface comprises a sawtooth structure, and a tip of the sawtooth structure faces the first side.

8. The electronic device according to claim 1, wherein the light exit surface comprises a sawtooth structure, and a distance between tips of adjacent sawtooth structures is one-twelfth to one-eighth of a diameter of the light-transmitting hole.

9. The electronic device according to claim 1, further comprising a sealing member, and the sealing member is arranged between the housing and the light guide member.

10. The electronic device according to claim 9, wherein the sealing member comprises a first sealing member and a second sealing member, and the first sealing member and the second sealing member are arranged adjacently.
